(19) United States
(12) Patent Application Publication
(10) Pub. No.: US 2011/0064633 A1
(43) Pub. Date: Mar. 17, 2011

(54) Multi-Functional Catalyst Block and Method of Using the Same

(75) Inventors: Yinyan Huang, Northville, MI (US); Christine Kay Lambert, Dearborn, MI (US)

(73) Assignee: FORD GLOBAL TECHNOLOGIES, LLC, Dearborn, MI (US)

(21) Appl. No.: 12/558,752

(22) Filed: Sep. 14, 2009

(51) Int. Cl. B01D 53/94; B01J 29/072

(52) U.S. Cl. 423/213.2; 502/100; 502/74

(57) ABSTRACT

According to one aspect of the present invention, there is provided a multi-functional catalyst block for reducing waste materials in the exhaust from a combustion engine. In one embodiment, the multi-functional catalyst block includes a substrate, a urea-hydrolyzing catalyst supported on the substrate, and a selective catalytic reduction (SCR) catalyst supported on the substrate. In another embodiment, the substrate is a wall-flow monolith configured as a particulate filter. In yet another embodiment, the substrate is a flow-through monolith.

### BACKGROUND

1. Technical Field

The present invention relates to a multi-functional catalyst block for reducing waste materials from the exhaust of a combustion engine.

2. Background Art

Like gasoline engines, diesel engines have been widely used for transportation and many other stationary applications. A combustion exhaust from diesel engines often contains a variety of combustion waste materials including unburned hydrocarbon (HC), carbon monoxide (CO), particulate matter (PM), nitric oxide (NO), and nitrogen dioxide (NO₂), with NO and NO₂ collectively referred to as nitrogen oxide or NOₓ. Removal of CO, HC, PM, and NOₓ from the combustion exhaust is needed for cleaner emissions. The combustion exhaust treatment becomes increasing important in meeting certain emission requirements.

Conventional emission control systems often use separate devices for the reduction of NOₓ and particulate matter. For example, a singular SCR (selective catalytic reduction) catalyst is used for converting NOₓ to nitrogen (N₂) and a singular particulate filter (PF) is used for removing particulate matter.

However, conventional emission control systems have met with limited use as they lack, among other things, concurrent and balanced consideration for emission control efficiency and space conservation.

There is a continuing need to provide an emission control system with features more suitable for meeting increasingly stringent industry and environmental standards.

### SUMMARY

According to one aspect of the present invention, there is provided a multi-functional catalyst block for reducing waste materials in the exhaust from a combustion engine. In one embodiment, the multi-functional catalyst block includes a substrate, a urea-hydrolyzing catalyst supported on the substrate, and a selective catalytic reduction (SCR) catalyst supported on the substrate.

In another embodiment, the substrate is a configured as a wall-flow particulate filter. In yet another embodiment, the substrate is configured as a flow-through device.

In yet another embodiment, the multi-functional catalyst block is provided with a first zone and a second zone downstream of the first zone relative to the combustion engine, wherein at least 90 weight percent of the urea-hydrolyzing catalyst is located in the first zone and at least 90 weight percent of the SCR catalyst is located in the second zone. In yet another embodiment, the urea-hydrolyzing catalyst and the SCR catalyst form a mixture on the substrate.

According to another aspect of the present invention, an emission control system is provided for reducing waste materials transported in an exhaust passage from a combustion engine. In one embodiment, the emission control system contains the multi-functional catalyst block described herein. In another embodiment, the emission control system further includes an oxidation catalyst disposed downstream of the engine and upstream of the multi-functional catalyst block. In yet another embodiment, the emission control system further includes an oxidation catalyst disposed downstream of the multi-functional catalyst block.

According to yet another aspect of the present invention, a method is provided for reducing waste materials in the exhaust of a combustion engine. In one embodiment, the method includes contacting the exhaust with a reductant and a multi-functional catalyst block as described herein to form a treated exhaust.

### BRIEF DESCRIPTION OF THE DRAWINGS

FIG. 1 schematically depicts an emission control system having a multi-functional catalyst block according to various embodiments of the present invention;

FIG. 2 schematically depicts an emission control system having a multi-functional catalyst block coupled with one or more oxidation catalyst according to various embodiments of the present invention;

FIG. 3A depicts an enlarged view of a section of the multi-functional catalyst block; and

FIG. 3B is a view similar to FIG. 3A illustrating another embodiment of the multi-functional catalyst block.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in the description and in the claims are to be understood as modified by the word “about” in describing the broader scope of this invention. Practice within the numerical limits stated is generally preferred. Also, unless expressly stated to the contrary, the description of a group or class of material as suitable or preferred for a given purpose in connection with the invention implies that mixtures of any two or more members of the group or class may be equally suitable or preferred.

As a matter of definition, and when used in this detailed description and in the claims:

“SCR” means selective catalytic reduction and includes a reducing catalyst which speeds or enhances a chemical reduction of NOₓ through the assistance of a reductant during lean operation;

“DPF” or “DF” refers to the particulate filter employed to remove particulate matter or the like;

“NOₓ” means nitrogen oxide and illustratively includes a mixture of compounds of nitric oxide (NO) and nitrogen dioxide (NO₂);

“Urea poisoning” means catalyst deactivation due to accumulation of urea molecules on the catalyst and may be manifested by the formation of undesirable urea derived byproducts; and

“Catalyst deactivation” means catalytic activity reduction due to urea poisoning, or reduction in NOₓ conversion in the case for SCR catalyst.

Emission control systems typically use selective catalytic reduction (SCR) catalysts to convert certain waste materials such as NOₓ to form less harmful counterparts such as N₂, for safer emissions. Ammonia is a commonly used reductant for SCR catalyst catalyzed NOₓ conversion. Decomposition of urea and subsequent reduction of NOₓ typically occurs according to the following scheme:

Urea decomposition:

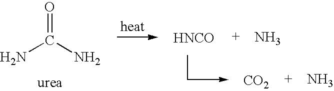

NOₓ reduction:

4NO+4NH₃+O₂→4N₂+6H₂O

6NO₂+8NH₃→7N₂+12H₂O

2NH₃+NO+NO₂→2N₂+3H₂O

Ammonia is often supplied by hydrolysis of liquid urea. Supply of the urea into the emission control system should be both time and amount controlled such that the urea is not present in substantial excess. Excess urea can be detrimental to the emission control system as excess urea can form urea deposits on and around catalysts, particularly SCR catalysts, and induce catalyst deactivation.

The present invention is capable of reducing waste materials from the exhaust of an internal combustion engine such as a diesel engine or a gasoline engine. Examples of the waste materials include unburned hydrocarbon (HC), carbon monoxide (CO), particulate matters (PM), nitric oxide (NO), and nitrogen dioxide (NO₂), with NO and NO₂ collectively referred to as nitrogen oxide or NOₓ.

With respect to the Figures that will be described in detail below, like numerals are used to designate like structures throughout the Figures.

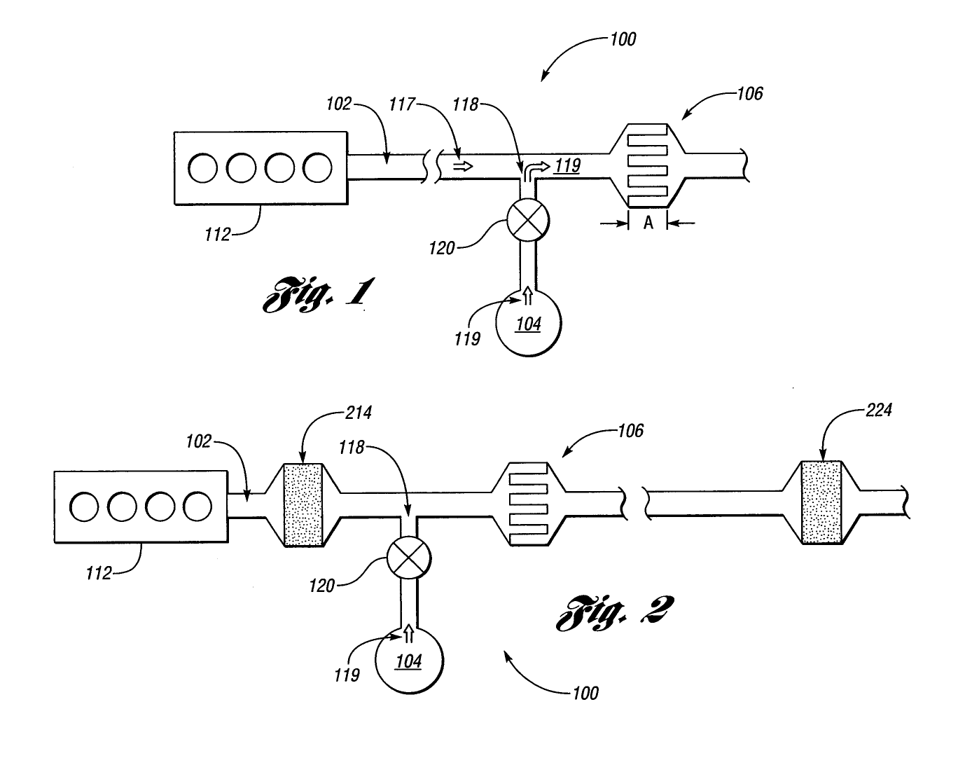

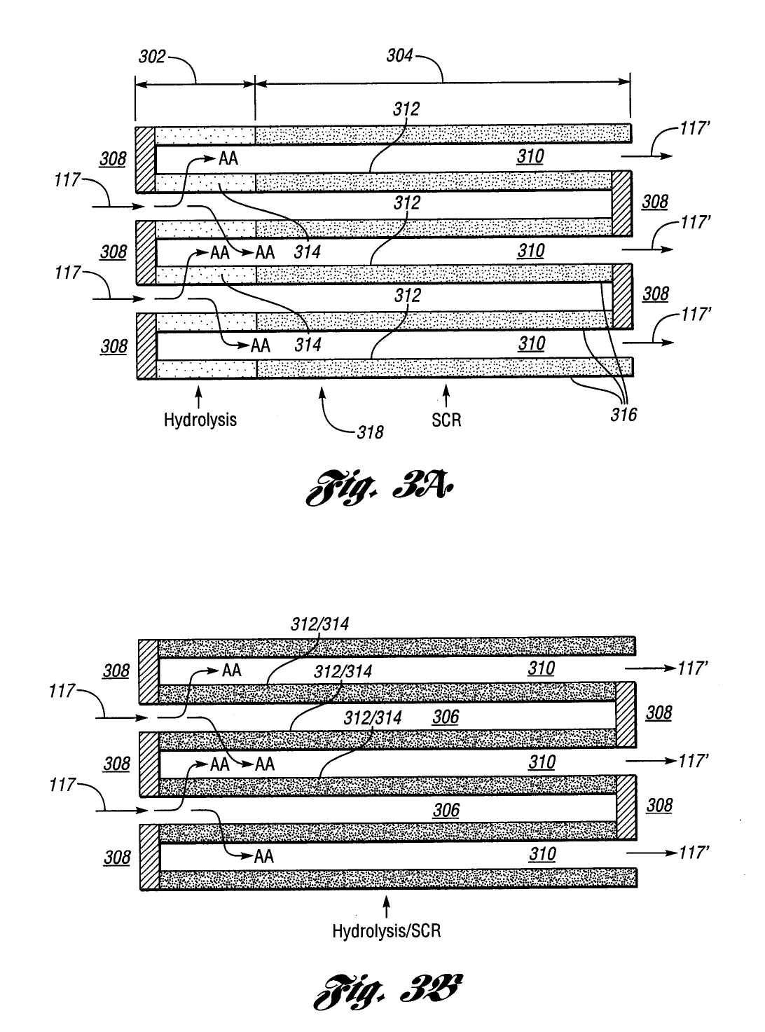

According to at least one aspect of the present invention, an emission control system, as generally shown at 100 in FIG. 1, is provided for reducing waste materials from the exhaust of an internal combustion engine. The emission control system 100 includes an exhaust passage 102 and a multi-functional catalyst block 106. As collectively shown in FIG. 1 and FIGS. 3A-3B, the multi-functional catalyst block 106 includes a urea-hydrolyzing catalyst 314 and a SCR catalyst 312, with both supported on a substrate generally shown at 318 having wall portions 316. Use of the multi-functional catalyst block 106, being a stand-alone or discrete unit, as described in more detail below, is believed to provide at least one of the following advantages: reduced catalyst deactivation due to urea poisoning, increased NOx conversion at lower temperatures, reduced exhaust backpressure and improved fuel economy, and reduced overall system complexity and improved vehicle packaging.

While not intended to be limited by any theory, one possible mechanism by which the multi-functional catalyst block is resistant to urea poisoning may be that the SCR catalyst is protected from the harmful effects, such as the formation of polymeric byproducts, of urea deposits as excess urea is hydrolyzed and hence reduced; and more catalytic sites of the SCR catalyst are made available for NOₓ conversion reactions. In addition, the catalyst material for the urea-hydrolyzing catalyst 314 is advantageously chosen and designed to have little or no impairment on the catalytic function of the SCR catalyst 312.

Several suitable variations can be had with respect to the multi-functional catalyst block 106 depending upon particular application needs at hand. For instance, and as depicted in FIGS. 3A-3B, the multi-functional catalyst block 106 can be configured as a wall-flow particulate filter having thereupon the urea-hydrolyzing catalyst 314 and the SCR catalyst 312, wherein the substrate 318 have relevant ends 308 plugged to force an exhaust 117 to flow in the direction of AA via the wall portions 316. Alternatively, the multi-functional catalyst block 106 can be configured as flow-through having thereupon the SCR catalyst 312 and the urea-hydrolyzing catalyst 314. In this latter variation, one or more particulate filters may be independently coupled to, either upstream or downstream of, the multi-functional catalyst block 106, for the removal of particulate matters.

It has been found that, the multi-functional catalyst block 106 as contemplated herein provides a synergistically broadened catalytic temperature range and hence enhanced NOₓ reduction efficiency in comparison to existing configurations, in part due to the fact that there is less impact of urea poisoning and hence less reduction thereof on NOₓ conversion. Moreover, the SCR catalyst is made more available for the NOₓ conversion reactions and the use no longer has to be diluted for urea hydrolysis as the latter is now compensated for by the inclusion of urea-hydrolyzing catalyst in the catalyst block 106.

It has further been found that, the multi-functional catalyst block 106 as applied in an emission control system such as one shown at 100 in FIG. 1, can provide substantial space reduction in a range of 10 to 40 percent relative to conventional systems.

In at least one embodiment, and as shown in FIGS. 1 and 3A-3B, the multi-functional catalyst block 106 is a wall-flow particulate filter having thereupon the urea-hydrolyzing catalyst 314 and the SCR catalyst 312.

Both catalysts can be disposed on the particulate filter in various ways. For instance, and as illustratively depicted in FIG. 3A, there is provided an enlarged cross-sectional view of the multi-functional catalyst block 106 in one variation. As shown in FIG. 3A, the multi-functional catalyst block 106 has a first zone 302 and a second zone 304. The second zone 304 is downstream of the first zone 302 as viewed from the location of the engine 112. The first and the second zones 302, 304 preferably sequentially align along the flow direction AA and therefore separate from each other. However, a clean-cut boundary is not necessarily required between the two zones 302, 304 and an incidental overlap of catalyst composition at the boundary does not affect the general practice of the invention.

In one variation, at least 60 percent, 70 percent, or 90 percent by weight of the urea-hydrolyzing catalyst 314 as present on the multi-functional catalyst block 106 is located in the first zone 302. In another variation at least 60 percent, 70 percent, 80 percent or 90 percent by weight of the SCR catalyst 312 as present on the multi-functional catalyst block 106 is located in the second zone 304.

The volume ratio between the first zone 302 and the second zone 304 can be adjusted such that the urea-hydrolyzing activities of the urea-hydrolyzing catalyst 314 and the NOₓ conversion activities of the SCR catalyst 312 can be coordinated depending upon a particular exhaust waste removal application at hand. In one variation, the volume ratio is from 1:10 to 10:1; from 1:5 to 5:1, from 3:10 to 10:3, from 2:5 to 5:2, or from 1:2 to 2:1.

The exhaust 117, along with an introduced reductant 119, such as urea for example, enters the multi-functional catalyst block 106 via entry channels 306 and exits via the wall portions 316 and subsequently exits via exit channels 310 to form a treated exhaust 117′, as respective ends 308 are plugged.

Because the urea-hydrolyzing catalyst 314 located in the first zone 302 is advantageously positioned upstream of the SCR catalyst 312 located in the second zone 304, and because in this particular configuration, the flow of the exhaust 117 enters and exits via the wall portions 316 as described above, the majority of the reductant 119 as contained within the exhaust 117 is forced to contact the urea-hydrolyzing catalyst 314 in the first zone 302 to form ammonia via a forced interaction between the reductant 119 and the hydrolysis catalyst.

In this embodiment, several design parameters can be adjusted to ensure that the exhaust 117 has been substantially acted upon by the urea-hydrolyzing catalyst 314 prior to its contact with the SCR catalyst 312. These parameters include, but are not limited to, an overall aspect ratio between length and diameter of the multi-functional catalyst block 106, porosity of the substrate walls 316, filter channel diameter, filter channel count, and coating ratio between the first and second zones 302, 304.

The resultant ammonia is then available for the NOₓ conversion reactions taking place in the second zone 304 which is more downstream of the first zone 302. As the exhaust 117 enters into the exit channels 310 through the wall portions 316, the majority of the urea, for instance, at least 50 percent, 60 percent, 70 percent, 80 percent, or 90 percent by weight, has been converted to ammonia via the forced interaction in the direction of the arrows shown.

Several advantages come with this design. For instance, the ammonia is “freshly” produced “in situ” from the reductant 119 right where it is needed for the SCR catalyst-assisted NOₓ conversion. Secondly, the reductant 119 is forced into contact with the urea-hydrolyzing catalyst 314 within the limited open areas of the channels 306 and as a result, the majority, for instance, at least 50 percent, 60 percent, 70 percent, 80 percent, or 90 percent by weight, if not all, of the reductant 119 is effectively utilized for urea hydrolyzing to ammonia. The amount of unused urea is effectively reduced, and the SCR catalyst 312 is relatively protected from the detrimental effect of the unused urea. Moreover, the catalytic sites of the SCR catalyst do not have to be used for urea hydrolysis purposes, more catalytic sites of the SCR catalyst are made available for NOₓ conversion reactions, and the catalyst block 106 can be made smaller in size than a conventional SCR catalyst.

The multi-functional catalyst block 106 can be provided with any suitable SCR catalyst loading concentration in grams per cubic inch of a loading volume, generally shown at “A” in FIG. 1. The loading concentration can be dependent upon the substrate porosity upon which the urea-hydrolyzing catalyst and the SCR catalyst are deposited. For instance, the SCR catalyst can have a loading concentration of 0.5 g/in³ (grams per cubic inch) for lower porosity filters, and can have a loading concentration of 2 g/in³ for higher porosity filters. In general and according to one or more embodiments of the present invention, the SCR catalyst loading concentration is in a range independently selected from no less than 0.1 g/in³, 0.2 g/in³, 0.3 g/in³, or 0.4 g/in³, to no greater than 4.0 g/in³, 3.5 g/in³, 3.0 g/in³, or 2.5 g/in³.

The multi-functional catalyst block 106 can be provided with any suitable urea-hydrolyzing catalyst loading concentration in grams per cubic inch of a loading volume, generally shown at “A” in FIG. 1. In certain instances, the urea-hydrolyzing catalyst 314 loading concentration is in a range independently selected from no less than 0.1 g/in³, 0.2 g/in³, 0.3 g/in³, or 0.4 g/in³, to no greater than 4.0 g/in³, 3.5 g/in³, 3.0 g/in³, or 2.5 g/in³.

In another variation, and as depicted in FIG. 3B, the urea-hydrolyzing catalyst 314 and the SCR catalyst 312 can be combined to form a mixture, a homogeneous mixture in certain instances, with the catalyst mixture being supported on the substrate 318.

Referring now back to FIG. 1, in the illustrated embodiment, the reductant 119 can be disposed within the exhaust passage 102 downstream of an engine 112. An aperture 118 is optionally located on the exhaust passage 102 and disposed between the engine 112 and the multi-functional catalyst block 106 as described herein to facilitate the introduction of the reductant 119 into the exhaust passage 102. The reductant 119, for reducing NOₓ to nitrogen N₂, is introduced into the exhaust passage 102 optionally through a nozzle (not shown). The introduction of the reductant 119 is optionally achieved through the use of a valve 120 which can be employed to meter the desired amount of the reductant 119 into the exhaust 117 from source 104. The exhaust 117 with the reductant 119 is then conveyed further downstream to along with the multi-functional catalyst block 106 for the reduction of NOₓ and the removal of the particulate matter.

In yet another embodiment, the range of the distance between the aperture 118 and the multi-functional catalyst block 106 may be independently selected from a range of no less than 0.5 centimeters, 10 centimeters, 20 centimeters, 30 centimeters, 40 centimeters, 50 centimeters, 60 centimeters, or 70 centimeters, to no greater than 140 centimeters, 130 centimeters, 120 centimeters, 110 centimeters, 100 centimeters, 90 centimeters, or 80 centimeters.

The reductant 119 may be of any material suitable for reducing NOₓ to a harmless, releasable substance such as nitrogen N₂. The reductant 119 may include ammonia, liquid urea, solid urea, or combinations thereof. As is known, when exposed to a warm or hot exhaust, urea readily decomposes to ammonia. In certain embodiments, a molar ratio NH₃/NOₓ is typically kept at a value predesignated so as to minimize NH₃ slip past the catalysts and out into the air. An exemplary molar ratio of NH₃/NOₓ is at or near one.

The substrate 318 as contained within the multi-functional catalyst block 106 for supporting the urea-hydrolyzing catalyst 314 and the SCR catalyst 312 may be a monolith, which is generally described as a ceramic block made of a number of substantially parallel flow channels. The monolith may be made of ceramic materials such as cordierite, mullite, and silicon carbide or metallic materials such as iron chromium alloy, stainless steel, and Inconel®. The flow channels of the monolith may be of any suitable size, and in certain instances are of a size of 0.5 to 10 millimeters in diameter. The channels can be substantially straight, hollow, and parallel to the flow of the exhaust, therefore flow obstruction to the exhaust is minimized. In the event that the substrate 318 is configured as a wall-flow particulate filter for additionally removing the particulate matters, the substrate can further include cordierite, silicon carbide, metal fiber, paper, or combinations thereof.

In at least one embodiment, the SCR catalyst 312 is generally zeolite based. The term “zeolite” generally refers to an aluminosilicate framework containing atoms of oxygen aluminum and/or silicon. An example of a natural zeolite is mordenite or a chabazite. Synthetic zeolites illustratively include type A as synthetic forms of mordenite, type B as ZSM-5® zeolites, and type Y as ultra-stabilized Beta zeolite. The framework structure of the zeolites often acquires an overall negative charge compensated for by exchangeable cations which may readily be replaced by other cations such as metal cations through methods including ion exchange.

The SCR catalyst 312 can include an alkaline earth metal exchanged zeolite, precious metal exchanged zeolite such as platinum based and/or a base metal exchanged zeolite such as copper and iron based zeolites. While any type of zeolite may be used, some suitable zeolites include X-type zeolite, Y-type zeolite, and/or ZSM-5 type zeolite.

When used in the SCR catalyst 312, the alkaline earth metal illustratively includes barium, strontium, and calcium. Suitable calcium sources for the alkaline earth metal include calcium succinate, calcium tartrate, calcium citrate, calcium acetate, calcium carbonate, calcium hydroxide, calcium oxylate, calcium oleate, calcium palmitate and calcium oxide. Suitable strontium sources for the alkaline earth metal include strontium citrate, strontium acetate, strontium carbonate, strontium hydroxide, strontium oxylate and strontium oxide. Suitable barium sources for the alkaline earth metal include barium butyrate, barium formate, barium citrate, barium acetate, barium oxylate, barium carbonate, barium hydroxide and barium oxide.

When used in the SCR catalyst 312, the rare earth metal may illustratively include lanthanum, cerium, and/or neodymium. Suitable neodymium sources for the rare earth metal include neodymium acetate, neodymium citrate, neodymium oxylate, neodymium salicylate, neodymium carbonate, neodymium hydroxide and neodymium oxide. Suitable cerium sources for the rare earth metal include cerium formate, cerium citrate, cerium acetate, cerium salicylate, cerium carbonate, cerium hydroxide and cerium oxide. Suitable lanthanum sources for the rare earth metal include lanthanum acetate, lanthanum citrate, lanthanum salicylate, lanthanum carbonate, lanthanum hydroxide and lanthanum oxide.

The SCR catalyst 312 may be prepared by any suitable methods. In the event that hydrogen-ion-exchanged acid zeolites are used, active ingredients may be incorporated into the zeolites in a manner illustratively shown as follows. A starting material is produced, including the zeolites, by mixing, milling and/or kneading the individual components or their precursor compounds (for example water-soluble salts for the specified metal oxides) and if appropriate with the addition of conventional ceramic fillers and auxiliaries and/or glass fibers. The starting material is then either processed further to form unsupported extrudates or is applied as a coating to a ceramic or metallic support in honeycomb or plate form.

A binder is optionally used to bring together all ingredients to form the SCR catalyst. The binder is used to prevent dissolution and redistribution of the ingredients. Possible binders include acidic aluminum oxide, alkaline aluminum oxide, and ammonium aluminum oxide. In certain particular instances, a soluble alkaline aluminum oxide with a pH of at least 8 is used as the binder.

Examples of suitable SCR catalysts are described in U.S. Pat. No. 4,961,917 to Byrne, the entire contents of which are incorporated herein by reference. Some suitable compositions include one or both of an iron and a copper metal atom present in a zeolite in an amount of from about 0.1 to 30 percent by weight of the total weight of the metal atoms plus zeolite. Zeolites are relatively resistant to sufur poisoning and typically remain active during a SCR catalytic reaction. Zeolites typically have pore sizes large enough to permit adequate movement of NOₓ, ammonia, and product molecules N₂ and H₂O. The crystalline structure of zeolites exhibits a complex pore structure having more or less regularly recurring connections, intersections, and the like. By way of example, suitable zeolites are made of crystalline aluminum silicate, with a silica to alumina ratio in the range of 5 to 400 and a mean pore size from 3 to 20 Angstroms.

Suitable SCR catalyst 312 to be used in the multi-functional catalyst block 106 can be of one composition, such as one composition of copper-containing zeolite or iron-containing zeolite; and can also be of a physical mixture of two or more catalysts in any suitable ratio. For instance, the SCR catalyst 312 can contain a mixture of Fe and Cu with any suitable weight ratio, for instance, of from 2:1, 3:1, 4:1, 5:1, 6:1, 7:1, 8:1, 9:1, to 10:1. Alternatively, the SCR catalyst 312 used herein can be an iron-containing zeolite or a copper-containing zeolite combined with one or more other metals selected from the group consisting of vanadium, chromium, molybdenum, tungsten, or any combinations thereof.

The SCR catalyst 312 and the urea-hydrolyzing catalyst 314 can be coated onto the substrate using any suitable method. One exemplary method of such a coating is illustrated in U.S. Pat. No. 7,229,597 to Patchett et al., the entire contents of which are incorporated herein by reference. In essence, the particulate filter with a desired porosity is immersed in a catalyst slurry which is then allowed to dry under compressed air. This dipping-drying process may be repeated until the desired level of coating is achieved. After coating, the particulate filter may be dried at a temperature, such as 100 degrees Celsius, and subsequently calcined at a relatively higher temperature, such as in the range of 300 to 500 degrees Celsius.

Optionally, and as shown in FIG. 2, an oxidation catalyst 214 can be disposed within the exhaust passage 102 downstream of the engine 112 and upstream of the multi-functional catalyst block 106. Oxidation catalysts that contain platinum group metals, base metals and combinations thereof help to promote the conversion of both hydrocarbon (HC) and carbon monoxide (CO) waste materials and at least some portion of the particulate matter through oxidation of these pollutants to carbon dioxide and water. The oxidation catalyst 214 generally helps to break down the waste materials in the exhaust to less harmful components. In particular, an exemplary oxidation catalyst 214 utilizes palladium and platinum catalysts to reduce the unburned hydrocarbon and carbon monoxide according to the following reaction formula: CO+O₂→CO₂. Removal of the HC and CO using the oxidation catalyst 214 helps to relieve some burden on the downstream staged catalyst unit 106 in remediating the exhaust.

In addition, the oxidation catalyst 214 also converts a certain portion of the nitric oxide (NO) to nitrogen dioxide (NO₂) such that the NO/NO₂ ratio is more suitable for downstream SCR catalytic reactions. An increased proportion of NO₂ in the NOₓ, due to the catalytic action of the upstream oxidation catalyst 214, enhances the reduction of NOₓ as compared to exhaust streams containing smaller proportions of NO₂ in the NOₓ component. Furthermore, the oxidation catalyst 214 helps enable soot removal and regeneration of the particulate filter for continuous engine operation.

The emission control system 100 may be further altered in its configuration without materially changing its intended function. For instance, a second oxidation catalyst 224 can be disposed downstream of the multi-functional block 106, as shown in FIG. 2. When used in concert with the first oxidation catalyst 214, the second oxidation catalyst 224 mainly serves to oxidize ammonia molecules that may have slipped through the exhaust passage 102 and to convert the slipped ammonia molecules to N₂. In addition, any unburned hydrocarbon that is left untreated may be oxidized at this point before final release into the air.

In at least one embodiment, the urea-hydrolyzing catalyst 314 contains at least one oxide. Examples of suitable oxides include titanium dioxide (TiO₂), aluminum oxide (Al₂O₃), silicon dioxide (SiO₂), zirconium oxide (ZrO₂), sulfur oxide (SO₃), tungsten oxide (WO₃), niobium oxide (Nb₂O₅), molybdenum oxide (MoO₃), aluminum oxide, yttrium oxide, nickel oxide, cobalt oxide, or combinations thereof. Without being limited by any theory, the oxide contained within urea-hydrolyzing catalyst 314 functions at least partially as hydrolyzation molecules that induce the hydrolyzation and hence breakdown of the excess urea and resultant alleviation of the deactivating effects of the excess urea.

The urea-hydrolyzing catalyst 314 can be applied to the multi-functional catalyst block 106 through any suitable methods. For instance, a precursor substance for forming the urea-hydrolyzing catalyst 314 is powdered, made into an aqueous slurry and then milled. The precursor substance is preferably provided in an amount such that a stoichiometric amount of ammonia can be generated based on the action of the urea-hydrolyzing catalyst 314 to be in alignment with the NOₓ conversion reactions. The amount for the precursor substance can be determined by experiment or else be calculated based on the molecular weight and/or solubility of the particular precursor substance used. As a result, the urea-hydrolyzing catalyst 314 is formed such that a pre-determined effectiveness of the SCR catalyst 312 is achieved in the reduction of NOₓ in NOₓ-containing waste materials.

The urea-hydrolyzing catalyst 314 produced in this way helps to impart a considerable long-term hydrothermal stability to the SCR catalyst 312 against the influence of urea poisoning. For example, the SCR activity of the multi-functional catalyst block 106 is not impaired by urea poisoning even after aging for 18 to 36 hours at 800 degrees Celsius or higher.

Suitable zirconium sources of the precursor substance for the urea-hydrolyzing catalyst 314 generally include zirconium dioxide, zirconium oxychloride, zirconium tert-butoxide, zirconium ethoxide, zirconium isopropoxide, and colloidal zirconium oxide.

Suitable titanium sources of the precursor substance for the urea-hydrolyzing catalyst 314 generally include titanium dioxide, titanium oxychloride, titanium oxynitrate, titanium isobutoxide, titanium n-butoxide, titanium tert-butoxide, titanium ethoxide, titanium isopropoxide, titanium methoxide, titanium n-propoxide, and colloidal titanium oxide.

Suitable aluminum sources of the precursor substance for the urea-hydrolyzing catalyst 314 generally include aluminum oxide, aluminum hydroxide, aluminum methoxide, aluminum n-butoxide, aluminum ethoxide, and aluminum isopropoxide.

Suitable silicon sources of the precursor substance for the urea-hydrolyzing catalyst 314 generally include silicon oxide and colloidal silicon oxide.

Suitable yttrium sources of the precursor substance for the urea-hydrolyzing catalyst 314 generally include yttrium oxide, colloidal yttrium oxide, and yttrium isopropoxide.

Suitable nickel sources of the precursor substance for the urea-hydrolyzing catalyst 314 generally include nickel oxide and nickel hydroxide.

Suitable cobalt sources of the precursor substance for the urea-hydrolyzing catalyst 314 generally include cobalt oxide and cobalt hydroxide.

According to at least another aspect of the present invention, a method is provided for reducing waste materials from the exhaust of an internal combustion engine. In one embodiment, the method includes contacting the exhaust with the multi-functional catalyst block 106 as described herein. In another embodiment, the method further includes contacting the exhaust with an oxidation catalyst 214, 224, prior to and or after the step of contacting the exhaust with the multi-functional catalyst block 106.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A multi-functional catalyst block for reducing waste materials in the exhaust from a combustion engine, comprising:
a substrate;
a urea-hydrolyzing catalyst supported on the substrate; and
a selective catalytic reduction (SCR) catalyst supported on the substrate.

2. The multi-functional catalyst block of claim 1, wherein the substrate is configured as a wall-flow particulate filter.

3. The multi-functional catalyst block of claim 1, wherein the substrate is a flow-through monolith.

4. The multi-functional catalyst block of claim 1, wherein the substrate has a first zone and a second zone downstream of the first zone, wherein at least 90 weight percent of the urea-hydrolyzing catalyst is located in the first zone and at least 90 weight percent of the SCR catalyst is located in the second zone.

5. The multi-functional catalyst block of claim 4, wherein a volume ratio between the first and second zones is from 1:10 to 10:1.

6. The multi-functional catalyst block of claim 1, wherein the urea-hydrolyzing catalyst and the SCR catalyst form a mixture on the substrate.

7. The multi-functional catalyst block of claim 1, wherein the SCR catalyst is an iron-containing zeolite, a copper-containing zeolite, or a combination thereof.

8. The multi-functional catalyst block of claim 2, wherein the substrate is provided with a porosity in a range of 40 to 85 volume percent.

9. An emission control system for reducing waste materials transported in an exhaust passage from a combustion engine, the system comprising:
a multi-functional catalyst block including a substrate, a urea-hydrolyzing catalyst supported on the substrate, and a selective catalytic reduction (SCR) catalyst supported on the substrate.

10. The emission control system of claim 9, wherein the substrate is configured as a wall-flow particulate filter.

11. The emission control system of claim 9, wherein the substrate is a flow-through monolith.

12. The emission control system of claim 9, wherein the multi-functional catalyst block has a first zone and a second zone downstream of the first zone, and wherein at least 90 weight percent of the urea-hydrolyzing catalyst is located in the first zone and at least 90 weight percent of the SCR catalyst is located in the second zone.

13. The emission control system of claim 12, wherein a volume ratio between the first and second zones is from 1:10 to 10:1.

13. The emission control system of claim 9, wherein the urea-hydrolyzing catalyst and the SCR catalyst form a mixture on the substrate.

15. The emission control system of claim 9, wherein the SCR catalyst is an iron-containing zeolite, a copper-containing zeolite, or a combination thereof.

16. The emission control system of claim 9, wherein the substrate is provided with a porosity in a range of 40 to 85 volume percent.

17. The emission control system of claim 9, further comprising an oxidation catalyst disposed downstream of the engine and upstream of the multi-functional catalyst block.

18. The emission control system of claim 9, further comprising an oxidation catalyst disposed downstream of the multi-functional catalyst block.

19. A method for reducing waste materials in the exhaust of a combustion engine, the method comprising:
contacting the exhaust with a reductant and a multi-functional catalyst block to form a treated exhaust, the multi-functional catalyst block containing a urea-hydrolyzing catalyst, a selective catalytic reduction (SCR) catalyst, and a wall-flow monolith substrate for supporting the urea-hydrolyzing catalyst and the SCR catalyst and for removing particulate matter.

20. The method of claim 19 further comprising contacting the exhaust with an oxidation catalyst prior to contacting the exhaust with the multi-functional catalyst block.
